(19) United States
(12) Patent Application Publication
(10) Pub. No.: US 2006/0010246 A1
(43) Pub. Date: Jan. 12, 2006

(54) Human-machine interface system and method

(76) Inventors: Kurt S. Schulz, Cincinnati, OH (US); Brent E. Meranda, Cincinnati, OH (US); Alex Rozenson, Liberty Township, OH (US); Jerry F. Koch, Cincinnati, OH (US)

Correspondence Address: RENNER OTTO BOISSELLE & SKLAR, LLP, 1621 EUCLID AVENUE, NINETEENTH FLOOR, CLEVELAND, OH, 44115, US

(21) Appl. No.: 10/531,656

(22) PCT Filed: Oct. 30, 2003
(86) PCT No.: PCT/US03/34629

§ 371 Date: Apr. 15, 2005

Related U.S. Application Data
(60) Provisional application No. 60/423,075, filed on Nov. 1, 2002.

(51) Int. Cl. G06F 15/16; G06F 15/177; G06K 9/36

(52) U.S. Cl. 709/232; 709/220; 382/253

(57) ABSTRACT

A system and method for providing a graphical human-machine machine interface for a machine having controllable parts. The system utililzes client-side graphics rendering for clients in communication over a wide area network to create an interactive interface. The rendered graphical objects are interactive and represent controllable parts of the machine such that the graphical objects change appearance to reflect interaction with the machine. Optionally, the system employs server-side graphics rendering for clients in communication via a local area network.

### RELATED APPLICATION DATA

This application claims the benefit of U.S. Provisional Patent Application No. 60/423,075, filed Nov. 1, 2002, the disclosure of which is herein incorporated by reference in its entirety.

### FIELD OF THE INVENTION

The present invention relates generally to human-machine interfaces for control applications. More specifically, the present invention relates to a system and method for providing a human-machine interface over a wide area network.

### BACKGROUND OF THE INVENTION

The World Wide Web (the “web”) is part of the Internet where information is organized in documents using hyper media. Each web document (“web page”) suitably contains information via hyperlinks. Such information is suitably in the form of text or embedded references to images, audio and video clips, or other documents. Web documents are accessible over the Internet through various computer applications called web browsers. Examples of browsers include: Netscape Navigator and Microsoft Internet Explorer, both which run on personal computers; as well as Pixo and Neomar, both of which operate on wireless handheld devices, such as personal digital assistants (“PDA”) or cellular phones. In an effort to make web pages uniformly readable by all types of browsers, the web has evolved such that web pages are typically specified in terms of content and format by one of several hardware and browser independent page description languages that are well known in the art. Some of these languages include: markup languages such as HTML, SHML, XML and XSL, and scripting languages such as JavaScript.

The Internet is often utilized for multimedia information retrieval. To access the Internet, computers interact with web servers using communication protocols that provide access to multimedia information (e.g., text, graphics, images, sound, video, etc.). Examples of such protocols include: Hypertext Transfer Protocol (“HTTP”) and Wireless Application Protocol (“WAP”). In the Internet paradigm, information is accessible at addresses, each of which is identified by a Uniform Resource Locator (“URL”). When using a web browser to access the Internet, a browser makes a request to the server on which the information or files is located (the identity of the server is contained in the URL) and, in return, the server returns to the client the desired information, e.g., a document or other object requested. The client's browser then interprets the received information and performs an appropriate function. Such function might be to display the returned information, execute a script, execute a plug-in, or store a file to a storage device at the client.

Information accessible via the Internet is suitably formatted in a multitude of languages. One of the most common page description languages is Hypertext Markup Language (“HTML”). HTML provides basic document formatting and allows programmers to specify “links” from one file to another. Other examples of markup languages include Extensible HyperText Markup Language (“xHTML”), Handheld Device Markup Language (“HDML”), Wireless Markup Language (“WML”), Extensible Markup Language (“XML”). Generally, when a browser accesses an HTML file, a “web page” is displayed.

To retrieve information from a specified URL address, browsers send requests to web servers. In handling user requests, servers to date have employed several methods. One such method of handling browser requests is by way of static resources. In handling a request for a static resource, a server simply loads the requested resource, such as a HTML file, and returns it to the user. Another method of handling requests is to dynamically generate resources through a Common Gateway Interface (“CGI”) implementation. In handling a request involving CGI technology, scripts are used to dynamically build the requested resource, e.g. dynamically generated resource, such as dynamically generated HTML. While more flexible than static resources, CGI handling has generally been considered slow and expensive in terms of computing and networking resources. In an attempt to solve this problem, Web Application Servers (“WAS”) were developed. Web Application Servers generally utilize advanced caching, employ resident scripts, and have advanced monitoring multithreading capability, allowing them to process incoming requests faster and more reliably.

Even with improvements in the manner in which servers handle browser requests, transferring graphics over the Internet remains problematic, mostly due to the bandwidth required to transfer images. Therefore, there exists a need in the art to provide improved data exchange between a client device and a local or host device, such that a machine can be remotely controlled and/or monitored in real time or near real time.

### SUMMARY OF THE INVENTION

In accordance with the present invention, there is provided a system for providing a graphical human-machine interface for a machine having controllable parts. The system comprises computer readable code on a computer readable medium. Such computer readable code receives information about at least one controllable part of the machine from a machine control device. Computer readable code also triggers a change in at least one assigned property of at least one graphical object corresponding to the at least one controllable part of the machine. In addition, computer readable code renders and displays the at least one graphical object following the change in the at least one assigned property.

Also in accordance with the present invention, there is provided additional computer readable code for receiving a user input associated with a displayed graphical object corresponding to the at least one controllable part of the machine. Computer readable code then triggers a change in the at least one assigned property of the associated graphical object and renders and displays the associated graphical object following the change in at least one assigned property. In addition, computer readable code sends data to the machine control device, the data representing an instruction to perform an associated machine function.

In further accordance with the present invention, there is provided a method or providing a graphical human-machine interface for a machine having a plurality of controllable parts. The method involves receiving information about at least one controllable part of the machine from a machine control device and then triggering a change in at least one assigned property of at least one graphical object corresponding to the at least one controllable part of the machine. Once the property is changed, the at least one graphical object is rendered and displayed.

Additionally, in accordance with the present invention, there is provided a system for providing a plurality of graphical human-machine interfaces for a machine having a plurality of controllable parts. The system comprises a machine control device in communication with the machine. A first computer in communication with the machine control device via a local area network comprises computer readable code for receiving information about at least one controllable part of the machine. The information received by the first computer suitably comprises rendered graphical objects. A second computer in communication with the machine control device via a wide area network comprises computer readable code for receiving from the machine control device information about at least one controllable part of the machine. The second computer also comprises computer readable code for triggering a change in at least one assigned property of at least one graphical object corresponding to the at least one controllable part of the machine. In addition, the second computer comprises computer readable code for rendering and displaying the at least one graphical object following the change in the at least one assigned property.

These and other features of the invention are fully described and particularly pointed out in the claims. The following description and drawings set forth in detail certain illustrative embodiments of the invention, these embodiments being indicative of but a few of the various ways in which the principles of the invention may be employed.

### DESCRIPTION OF THE DRAWINGS

FIG. 1A is a flowchart generally depicting a method for providing a machine-side graphical human-machine machine interface for a machine having controllable parts in accordance with the present invention;

FIG. 1B is a flowchart generally depicting a method for providing a human-side graphical human-machine machine interface for a machine having controllable parts in accordance with the present invention;

FIG. 2 is a system diagram illustrating a machine having controllable parts in a network environment in accordance with the present invention;

FIG. 3 is a system diagram illustrating a machine having controllable parts in a local area and wide area network environment in accordance with the present invention; and

FIG. 4 is representation of an interface having a plurality of controls in accordance with the present invention.

### DETAILED DESCRIPTION OF THE INVENTION

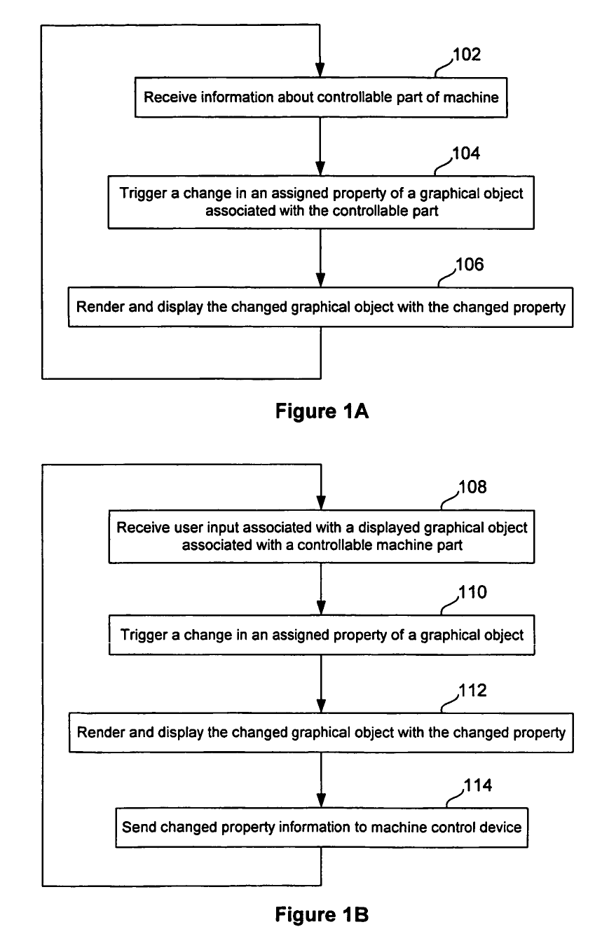

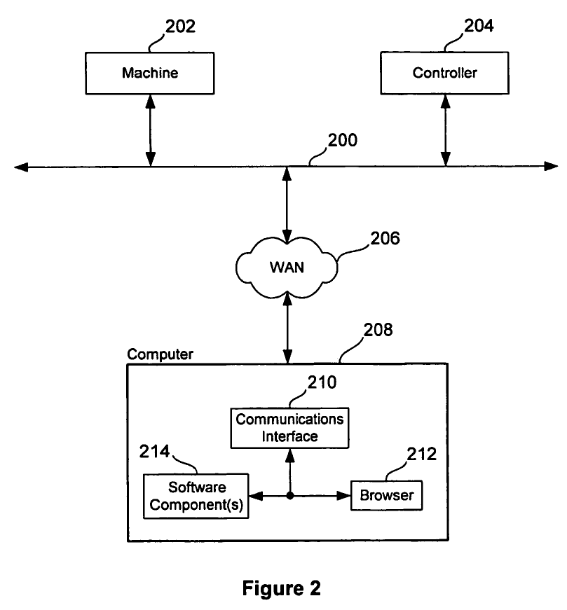

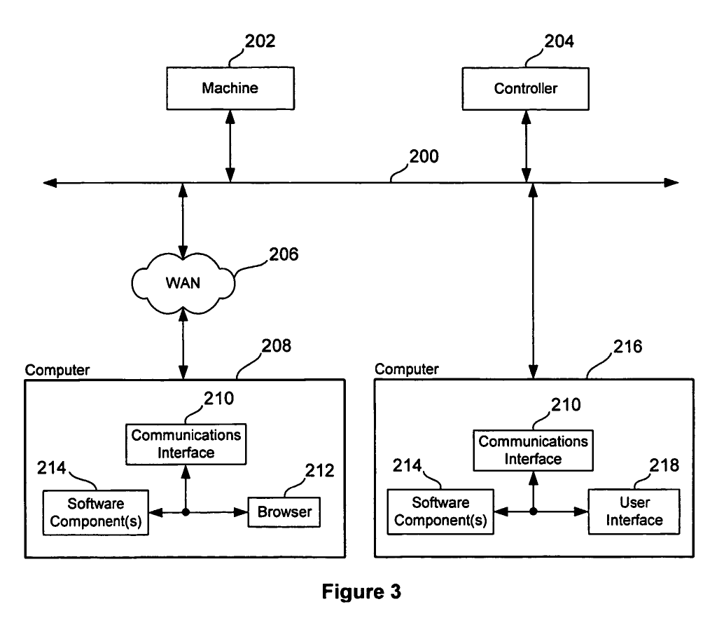

Turning now to FIG. 1A, there is presented a general method for providing a human-machine interface for controlling a machine (e.g. the machine 202 of FIGS. 2 and 3) having at least one controllable part in accordance with the present invention. The various alternate embodiments and devices used to accomplish such methodology will be set forth in greater detail below. As shown, the basic flow generalizes the information flow from machine to human. Flow commences at process block 102 wherein information about at least one controllable part of a machine having a plurality of controllable parts is received. Flow then progresses to process block 104 wherein a change is made to an assigned property of a graphical object associated with the controllable part about which information was received. Progression then flows to process block 106 wherein the changed graphical object is rendered and displayed with the new property. Flow then suitably loops back to process block 102 wherein more information about a controllable part of the machine is received.

Turning now to FIG. 1B, there is presented a general method for providing a human-machine interface for controlling a machine (e.g. the machine 202 of FIGS. 2 and 3) having a plurality of controllable parts in accordance with the present invention. The various alternate embodiments and devices used to accomplish such methodology will be set forth in greater detail below. As shown, the basic flow generalizes the information flow from machine to human. Flow commences at process block 108 wherein a user input is received. The received input is suitably associated with a displayed graphical object, which is in turn suitably associated with a controllable aspect of the controllable machine. Flow then progresses to process block 110 wherein a change is made to an assigned property of the graphical object. Progression then flows to process block 112 wherein the changed graphical object is rendered and displayed with the new property. In addition, as shown in process block 114, information relating to the changed property is then sent to a machine control device. Flow then suitably loops back to process block 108 wherein additional user input associated with graphical objects is received.

Turning now to FIG. 2, an illustration of a network environment for practicing the present invention is provided. The system comprises a data transport network 200 illustrative of a local area network (“LAN”) and/or wide area network (“WAN”) environment in which an embodiment of the present invention is provided, such as a packet-switched TCP/IP-based global communication network. The network 200 is suitably any network and may be comprised of physical layers and transport layers, as illustrated by a myriad of conventional data transport mechanisms like Ethernet, Token-Ring™, 802.11(b), or other wire-based or wireless data communication mechanisms as will be apparent to one of ordinary skill in the art.

Connected to the network 200 is a controller 204 (also referred to herein as a machine control device). As shown in FIG. 2, machine 202 and controller 204 are suitably connected to the network 200, which is suitably a LAN. It will also be appreciated that the machine 202 and controller 204 can also be connected directly to one another. The machine 202 is suitably any machine with one or more controllable aspects or parts, such as limit switches, sensors, motor drives, and the like, as will be appreciated by those skilled in the art. As used herein, the term machine is used in its broadest sense and suitably includes self contained devices (e.g., an automobile, a robotic arm, a printer, a surgical apparatus and so forth) and systems that include multiple devices (e.g. a steel producing factory, a newspaper printing facility, an assembly line, a semiconductor chip plant, and so forth). Also, the parts of the machine 202 need not be limited in to a single location. It is within the scope of the present invention that multiple parts a machine 202 communicate via a LAN or even a WAN.

In communication with the machine 202 is the controller 204, which is suitably any machine control device. The controller 204 is suitably a programmable logic controller (“PLC”), a PC-based logic controller (“PCLC”), a computer having control software, or the like, including combinations thereof. The controller 204 preferably supports IEC 61131 languages, could be capable of controlling simultaneous tasks, could support fieldbus I/O, and could utilize solid state storage, such as Compact FLASH storage media. It will be appreciated by those skilled in the art that each machine 202 has specific control requirements, and that the specific configuration of the controller 204 is typically machine-dependent.

In addition, the controller 204 can act as either a client machine or server machine on a network. For example, the controller 204 suitably functions as a server, which is suitably any server, such as a control server, an application server, a database server, a web server, or the like. In addition, the controller 204 may operate as or in conjunction with at least one external server, such as a control server and a web server. In one embodiment, the controller 204 functions as a client or server in communication with a web server via a LAN. A web server (not shown) suitably receives information from the controller 204 and makes such information available to clients via the WAN 206. Any type of network configuration, such as configurations comprising intermediary servers, is suitably utilized. It should be stressed and understood by those skilled in the art that any configuration of devices comprising a machine 202 and a controller 204 is considered to be within the scope of the present invention whenever information about the machine 202 from the controller 204 is available to a client via a WAN 206.

In communication with the controller 204 via the WAN 206 is a computer 208. In one exemplary environment, the WAN is the Internet. Thus, a data path is formed between computer 208 and machine 202. The computer 208 is suitably any device capable of functioning as a client to display information received from controller 204 and send data to controller 204 in response to human input. As such, the computer 208 is suitably either a server or client running on any operating system (“OS”), such as Windows NT, Windows 2000, Windows XP, Windows CE, Unix, Linux, Macintosh, PALM or other operating system. Such computer 208 is suitably a PC or a wireless handheld device, such as a PDA or a cell phone, all of which comprise a display for displaying graphical objects and means for receiving user input.

The computer 208 suitably comprises hardware and software systems designed to request information from or request processing of information from servers. The computer 208 suitably includes at least one processor (not shown) for executing instructions, usually in the form of computer readable code, to carry out a specified logic routine. The processor can be electrical or optical in nature.

The computer 208 also has memory (not shown) for storing data, software, logic routine instructions, computer programs, files, operating system instructions, and the like. The memory suitably comprises several devices and includes, for example, volatile and non-volatile memory components. Volatile memory components typically do not retain data values upon a loss of power. Non-volatile memory components retain data upon a loss of power. Thus, the memory suitably includes, for example, random access memory (“RAM”), read-only memory (“ROM”), hard disks, floppy disks, compact disks (including, but not limited to, CD-ROM, DVD-ROM and CD-RW), tapes, and/or other memory components, plus associated drives and players for these memory types. In addition, the RAM may comprise, for example, static random access memory (SRAM), dynamic random access memory (“DRAM”), magnetic random access memory (“MRAM”), and/or other such devices. The ROM may comprise, for example, programmable read-only memory (“PROM”), erasable programmable read-only memory (“EPROM”), electrically erasable programmable read-only memory (“EEPROM”), and/or other like memory devices.

The computer 208 suitably comprises a communications interface 210 for sending and receiving information, such as via the WAN 206. The communications interface is suitably, for example, a modem, network card and/or other type of transceiver. The communications interface 210 enables the computer 208 to send and receive data signals, voice signals, video signals, and the like, as is well known in the art. As one skilled in the art will appreciate, multiple communication interfaces 210 can be provided. The communications interface 210 can be configured for coupling to various types of media, such as a satellite transceiver, a coaxial cable, a fiber optic cable, a telephone cable, a network cable, a wireless transceiver, or the like.

The computer 208 also has a display (not shown). Such display is suitably a any type of display, such as a cathode ray tube (“CRT”), a liquid crystal display (“LCD”), a plasma display, an electroluminescent display, indicator lights, light emitting diodes (“LEDs”), or any other visual display.

The computer 208 also suitably includes at least one input device (not shown) such as a keyboard, a mouse and a microphone, a keypad (not shown), a touch pad (not shown), a touch screen (not show), a joystick (not shown), a digital camera (not shown), a scanner (not shown), a digital pen (not shown), a data card is reader (e.g., a smart card reader) (not shown), and a biometric sensor (not shown), etc., as will be appreciated by those skilled in the art.

The computer 208 suitably interacts with a server using a communication protocol (such as Hypertext Transfer Protocol (“HTTP”) and Wireless Application Protocol (“WAP”)) to provide a user with access to multimedia information (e.g., text, graphics, images, sound, video, etc.). As such, the computer 208 suitably comprises a browser 214, such as Netscape Navigator or Microsoft Internet Explorer, Pixo, Neomar, or the like, for making requests to and receiving information from a server, such as a web server. The browser 214 functionality is also suitably embodied in proprietary software.

In addition, the computer 208 suitably comprises a software component 212 for providing the human-machine interface functionality described herein. The software component 212 is computer readable code, whether compiled or interpreted, on a computer readable medium written in any one of a myriad of programming languages currently available. In one embodiment, the software component 212 comprises object-oriented, platform independent modules. As such the software component 212 is any piece of prewritten code that defines interfaces that can be called to provide the functionality that the component encapsulates. Further, the software component 212 is suitably callable from multiple languages, or from multiple environments, or OS. It should be noted that the software component 212 of the present invention is suitably designed for any language binding, such as Common Object Request Broker Architecture (“CORBA”), JAVA, .NET, COM, DCOM, C++, ActiveX, etc. as will be appreciated by those skilled in the art. In addition, the software component 212 is also suitably a plurality of software modules or components configured to interact with one another and the computer 208 to provide the functionality described herein. Further, the software component 212 suitably comprises at least one compiled component that is callable from and executable on a plurality of OS. For example, the software component 212 can comprise a Java Bean, such as an “Entity Bean,” “Session Bean,” or “Message-Driven Bean.” In addition, the software component suitably comprises computer readable code that is scriptable, or modifiable and executable through scripting, as will be appreciated by those skilled in the art.

The controller 204 functions to control the machine 202. Thus information is transmitted bi-directionally between the machine 202 and the controller 204. Such information suitably comprises: machine status or property information, data transfer information, machine configuration information, error and alarm information, networking information, user information, and the like. The machine 202 suitably sends information to the controller 204 and the controller 204 suitable sends information, as well as commands and instructions to the machine 202. The information sent between machine 202 and controller 204 is suitably formatted as an IEC 61131 language and may utilize fieldbus I/O technology, depending on machine 202 and controller 204 configuration.

The information from the machine 202 received by the controller 204 is then suitably sent to the computer 208. In one embodiment, the information is sent via the WAN 206, such as the Internet. However, it is also within the scope of the present invention to send information via a LAN or other data transport network, such as by direct interface between controller 204 and computer 208. In order to prompt the controller 204 to send information to the computer 208, an algorithm on the computer 208 suitably queries the controller 204 periodically. Depending on system configuration, the computer 208 might suitably query a web server (not shown) for information from the controller 204.

The controller 204, therefore, sends to the computer 208 information about at least one controllable aspect or part of the machine 202 that suitably comprises a plurality of controllable parts. Such controllable parts include, but are not limited to: sensors, switches (including limit switches and the like), motor drives, mechanical components, etc. The information sent from controller 204 to computer 208 may be of any form. Sending pre-rendered graphic information is cumbersome when transferring data over a WAN, such as via the Internet. Therefore, if pre-rendered graphics are sent to computer 208, the content is suitably optimized, such as by methods available through utilizing scalable vector graphics (“SVG”), before delivery. Specifically, the information received at computer 208 is suitably information corresponding to at least one controllable part of the machine 202.

SVG is a vector graphics language designed such that its code can be incorporated directly into XML or HTML code, which is the code underlying many web pages. The incorporation of graphics directly into XML and HTML provides several advantages. Such advantages include: easily-defined links to a part or portion of an image, images that are resolution independent such that the image can automatically be scaled up or down to fit into any size display, searchable text for text images, and animation support.

As described in “1.1 Specification, W3C Recommendation, 30 April 2002,” herein incorporated by reference in its entirety, SVG is a standardized XML language for describing 2D graphics via vector graphics, text and raster graphics. Graphical formats can be defined by cascading style sheets (“CSS”) in order to confer standard appearance to a group of graphical objects. The style sheet grouping permits modification of the appearance of several similar objects by simply modifying the CSS. Integration of SVG into an existing data object model (“DOM”) allows SVG elements to be controlled and modified by JavaScript/Java interfaces. Furthermore, because SVG allows developers to dynamically change image attributes, the number of necessary image files is reduced. For example, a navigation button that normally requires a minimum of two raster files can be replaced by a single SVG file. Rollover states and behaviors are specified via scriptable attributes such as color, shape, size, text, or opacity.

The following describes in more detail some of the capabilities and advantages of SVG. SVG viewers simulate the “painter's algorithm”, which means that overlapping areas are essentially “painted over,” or that underlying monitor pixels are shining through. Objects up to 2.5D (which applies to terrain models) can be represented correctly by utilizing a painter's algorithm. The rendering sequence is established according to object sequence within the file. Objects that are featured on top in the file are rendered first. Following objects paint over underlying objects, according to the chosen pattern and opacity. Single objects may be united to form a group such that graphical formats and transformations affect entire groups. Groups are assigned drawing layers (layer or canvas in desktop publishing programs), which may overlap.

Similar to HTML, and conventional text or graphical editing programs, SVG is allows developers to define formats, style sheet objects. The style sheet allows developers to globally format (colors, fillings, lines, text properties, positions, etc.) groups of alike graphical objects. All objects to which a style sheet has been assigned are modified automatically when an associated style sheet definition (property) is changed. SVG maintains complete style sheet compatibility with HTML. Thus, the same formatting applied to HTML can be applied to SVG elements as well. Groups may also contain inherited formatting, such may be acquired by way of undergroups and underformats. In addition, style sheet format data may be saved in external files. Therefore, entire projects can be controlled centrally or by assigning parameters to single groups and objects.

Basic geometrical elements in SVG include: rectangle, circle, ellipse, line, polyline, polygon, and others. Some of the basic elements are able to receive supplementary parameters, such as round corners. All SVG objects may be clipped and masked. They may also serve as a “clipping-path”, which includes both raster images and text.

Color values are defined in sRGB standard, which is a color domain for the Internet with parameters specific to display devices. As with HTML, values are determined in hexadecimals. Each and every filling, including lines and texts, may take on a transparency value. Lines may be defined by attributes such as thickness, line end type, vertex markers, broken line mode, broken line offset, etc. On both ends, markers (such as arrows) may also be allocated. As a special feature, markers may also be allocated to every vertex, which is helpful with minor angle changes.

Basic interaction features of an SVG viewer include zooming, panning, return to original view, and a display print option. Like HTML, hyperlinks may be used to refer to other files, or to other elements within an SVG document. You can also refer to pre-defined “view-elements,” which allows developers to link to a specific location or part of an SVG element. In SVG, there are three types of event categories: mouse events, keyboard events, and state change events (concerning display and SVG file loading state), any of which may be combined. Event handling is analogous to that of HTML.

SVG applications include the switching on and off of elements and layers, changing graphical attributes, reacting to mouse events, linking windows (combining various views, e.g. overview and main map), moving elements interactively, scaling and rotating elements (e.g. didactical puzzles). In addition, databases can be linked using server CGI scripts, Java applets, and/or Java servlets.

HTML, coupled with CSS and JavaScript, allows developers to create simple animations, but the technology is very limited. For instance, if a developer wants to move an object from A to B, he must pre-define all intermediate steps. In contrast, SVG offers interpolation. SVG's animation component is compatible with synchronized multimedia integration language (“SMIL”). With SVG, developers can determine animation variables such as: start time of animation (usually relative to an event), duration of animation, end time of an animation, animation repetition, number of repetitions, etc. Depending on object type, various parameters may also be animated, such as: color value, position, position along a path, rotation, scale, and many others.

SVG also makes use of metadata, which includes information relative to authorship, publication date, version, title, description, etc. Such metadata can be embedded into an SVG file in the same manner as one would embed external code (e.g. JavaScript). As with Virtual Reality Modeling Language (“VRML”), SVG offers the possibility to re-use file elements that were described earlier and explicitly identified. Thus one may pre-define graphical objects and groups and re-use them, even if modified, e.g. after transformation. Extensibility is one of the most important features of SVG, as is the case with any DOM/XML compatible specification. Since SVG is defined in XML, any other standard which is also defined in XML, such as MathML, XHTML, SMIL, and many others, can be embedded in and accessed with SVG.

As discussed above, graphics are deposited in SVG source code, which is interpreted by a client (the browser), and displayed accordingly. Therefore, it is possible to dynamically generate SVG through scripting (CGI, Java, etc.), databases, and other applications. In order to limit file size, it is possible to compress an entire SVG file before sending it to the web browser. One of the many advantages made available by SVG is that client machines can perform graphics rendering, which reduces server loads and decreases data transmission between the client and server. Client-side rendering can dramatically improve the user experience by decreasing the time period required to re-render graphics in response to user input. In addition, if the client platform has limited processing resources (PDAs and cell phones, for example), the server can pre-render and optimize content before delivery. In both cases, the source content is the same.

Because the appearance of a rendered SVG graphical object is based on assigned property information, such as in a data object model (“DOM”), changing an assigned property of the graphical object effectuates a change in the appearance of the graphical object once rendered. Assigned properties of graphical objects are suitably stored in at least one style sheet, such as a cascading style sheet (“CSS”), extensible style sheet (“XSL”), or the like. Storage of properties in style sheets allow for global formatting (colors, fillings, lines, text properties, positions, etc.) for groups of alike graphical objects. All objects to which a style sheet has been assigned are modified automatically when an associated style sheet definition (property) is changed. Formats are suitably inherited to groups, undergroups and underformats. In addition, style sheet format data is suitably saved in external files. Therefore, entire projects may be controlled centrally or by assigning parameters to single groups and objects.

Having thus described the system, the flow of information throughout the system will now be specifically addressed. The computer 208 suitably receives information from controller 204, such as via the WAN 206, through communication interface 210. Upon receipt of such information, at least one software component 212 interprets the received information and triggers a change in an assigned property of a graphical object that corresponds to the controllable part of the machine about which information was received. Such graphical objects suitably comprise representations of physical controls on the machine 202 or controller 204, or graphical representations of controllable parts of the machine. In one embodiment, graphical objects are SVG objects. The SVG objects are suitably rendered at the computer 208. Further, SVG objects are capable of being displayed at the same size on displays of different resolutions.

At least one software component 212 is suitably configured to receive the information sent to the computer 208 from controller 204 (see FIG. 1, 102). Further, at least one software component 212 interprets the received information and triggers a change in an assigned property of the graphical object associated with the controllable part of the machine about which the information pertains (see FIG. 1, 104). After a change in an assigned property is triggered, at least one software component 212 effectuates a change in an assigned property of the graphical object. The at least one software component 212 that effectuates a change is suitably “called” by another software component 212. Alternately, the at least one software component 212 that triggers the property change also comprises functionality to effectuate the triggered change.

After a property change has been effectuated, at least one software component 212 renders and displays the graphical object with the changed property (see FIG. 1, 106). Again, the at least one software component 212 that renders and displays that graphical object is suitably “called” by another software component 212. Alternately, the at least one software component 212 that effectuates the property change also comprises functionality to render and display the at least one graphical object. Once rendered, the graphical object's visual appearance suitably differs from its original appearance, thus reflecting a change in an aspect or part of machine 202 or the control thereof. Thus, the flow of information from machine 202 to user by way of computer 208 is complete.

The system of FIG. 2 also provides information flow from a user of computer 208 to machine 202. The computer 208 suitably comprises at least software component for receiving a user input associated with a displayed graphical object corresponding to at least one controllable part of machine 202 (see FIG. 1, 108). Such user input is suitably received via an input device (not shown) as will be appreciated by those skilled in the art.

At least one software component 212 interprets the user input and triggers a change in an assigned property of the graphical object associated with the user input (see FIG. 1, 110). After a change in an assigned property is triggered, at least one software component 212 effectuates a change in the assigned property. The at least one software component 212 that effectuates a change is suitably “called” by another software component 212. Alternately, the at least one software component 212 that triggers the property change also comprises functionality to effectuate the triggered change. A change in an assigned property of a graphical object suitably includes changing existing properties of the graphical object, or dynamically adding at least one property to the graphical object, such as by way of scripting.

After a property change has been effectuated, at least one software component 212 renders and displays the graphical object with the changed property (See FIG. 1, 112). Again, the at least one software component 212 that renders and displays is suitably “called” by another software component 212 Alternately, the at least one software component 212 that effectuates the property change also comprises functionality to render and display the at least one graphical object. Once rendered, the graphical object's visual appearance suitably differs from its original appearance, thus reflecting a change in an aspect or part of machine 202 or the control thereof.

In addition, because the graphical object associated with the user input corresponds to a controllable part or aspect of the machine 202, the change in the graphical object corresponds to a change in a controllable part of the machine 202, thereby allowing the user to control and interface with the machine 202. Thus, at any time after at least one software component 212 interprets the user input and triggers a change in an assigned property of the graphical object associated with the user input (see FIG. 1, 104), at least one software component suitably sends information about the change to the controller 204 (see FIG. 1, 114). The at least one software component that sends information about the change to the controller 204 is suitably “called” by another software component. Alternately, the at least one software component 212 that interprets the change also comprises functionality to send information about the change to the controller 204. The data sent to the controller 204 suitably represents an instruction to perform an associated machine function associated with the graphical object that is associated with the user input.

The path that the information travels from the computer 208 to the controller 204 depends on the configuration of the system as explained above. For example, the information travels from the computer 208 to the controller 204 via the WAN 206, such as by way of an intermediate web server (not shown). The controller 204, after receiving the information from the computer 208, controls the machine 202 in accordance with the information received. Thus, the flow of information from user to machine 202 is complete and a machine 202 can be controlled from a remote location by a user of the computer 208.

Turning now to FIG. 3, an illustration of a network environment for practicing the present invention via LAN and/or WAN is provided. As shown, the machine is suitably controlled locally and/or remotely. The system comprises a data transport network illustrative of a LAN 200 and a WAN 206, such as a packet-switched TCP/IP-based global communication network, in which an embodiment of the present invention is provided. The machine 202, controller 204, computer 208, and flow of information therein are described above with reference to the system of FIG. 2.

The computer 216 is suitably any device capable of functioning as a client to display information received from controller 204 and send data to controller 204 in response to human input. The descriptions of the various components of the computer 208 are equally applicable to the computer 216.

In one embodiment, the interaction between controller 204 and computer 216 is different than the interaction between controller 204 and computer 208. The information from the machine 202 received by the controller 204 is suitably sent to the computer 216 via a LAN. However, it is also within the scope of the present invention to send information via other data transports, such as by direct interface between controller 204 and computer 216. Further, the computer 216 and controller 208 are suitably one device. Depending on system configuration, the computer 216 might suitably query a server (not shown) for information from the controller 204. The controller 204, therefore, sends to the computer 216 information about at least one controllable aspect or part of the machine 202 that suitably comprises a plurality of controllable parts.

The information received by the computer 316 suitably comprises pre-rendered graphics. In one embodiment, the computer 316 receives graphics rendered through the use of GDI+, a graphical device interface technology available with the Windows XP OS. However, as will be appreciated by those skilled in the art, any graphics technology that supports server-side rendering is suitably used.

Specifically, information comprising rendered graphical objects corresponding to at least one controllable part of the machine 202 is received at computer 216 through communication interface 210. At least one software component 212 is suitably configured to receive information from controller 204. The at least one software component 212 suitably interacts with User Interface 218 to display the rendered graphical object. Like the software component 212, the User interface 218 is suitably computer readable code, whether compiled or interpreted, on a computer readable medium written in any one of a myriad of programming languages currently available as will be appreciated by those skilled in the art. Further, the User Interface 218 is suitably another software component callable from software component 212.

Accordingly, information received by computer 208 via the WAN 206 suitably comprises graphical object information that computer 208 uses to render graphical objects. In contrast, information received by computer 216 via a LAN 200 suitably comprises pre-rendered graphical objects. Such pre-rendered graphical objects are suitably rendered by controller 204 or by an intermediary server (not shown).

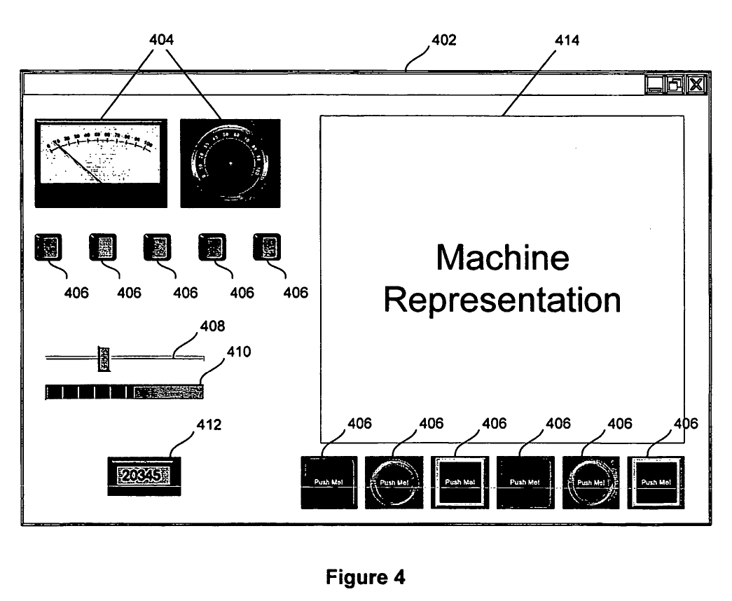

Turning now to FIG. 4, provided is a representation of an interface viewable with a browser, such as the browser 214 (FIG. 2). The interface 402 is an example of the type of display which is suitably presented to a user in accordance with the system and method described above. The interface 402 suitably comprises at least one and preferably a variety of graphical objects, such as gauges 404 and dials 404, buttons 406, sliders 408, meters 410, counter 412, and the like. Accordingly, the graphical objects are suitably representations of physical controls on the machine 202 and/or the controller 204. The graphical objects are also suitably representations of parts or aspects of the machine 202. The controls are suitably interactive in that once changed or activated, the graphical object is displayed differently. The interface 402 is suitably implemented with a visual display and/or and auditory output (e.g. speaker) (not shown) connected to and driven by any of the computer 208 and 216.

The interface 402 also suitably comprises a representation of the machine 202. If the machine 202 is a mechanical object, the representation 414 is suitably an image of the object or a portion thereof. The representation 414 of the machine is suitably modified so that it best illustrates the nature of the changes made by interaction with graphical objects on the screen and/or movement of machine 202 parts (e.g. detected by sensor and processed as a graphical object as described herein). In addition, the representation 414 of the machine is also suitably interactive, can be zoomed, and suitably utilizes functionality available with SVG.

It will be appreciated by persons skilled in the art that numerous variations and/or modifications may be made to the invention as shown in the specific embodiments without departing from the spirit or scope of the invention as broadly described. The present embodiments are, therefore, to be considered in all respects as illustrative and not restrictive. Such other features, aspects, and expected variations and modifications of the examples are clearly within the scope of the invention where the invention is limited solely by the scope of the following claims.

What is claimed is:

1. A system for providing a graphical human-machine interface for a machine having controllable parts, the system comprising:
a) computer readable code on a computer readable medium for receiving information about at least one controllable part of the machine from a machine control device in communication with the machine;
b) computer readable code on a computer readable medium for triggering a change in at least one assigned property of the at least one graphical object corresponding to the at least one controllable part of the g machine; and
c) computer readable code on a computer readable medium for rendering and displaying the at least one graphical object following the change in the at least one assigned property, wherein the at least one rendered and displayed graphical object is a scalable vector graphic (SVG) object.

2. The system of claim 1, wherein the computer readable code of a), b), and c) is configured be executed by a computer in communication with the machine control device via wide area network.

3. The system of claim 2, wherein the wide area network is the Internet.

4. The system of claim 1, wherein information received from the machine control device comprises data representative of that selected from the group consisting of: status information, property information, configuration information, error information, alarm information, user information, and combinations thereof.

5. The system of claim 1, wherein the machine control device is selected from the group consisting of: PLC, PCLC, computer with control software, and combinations thereof.

6. The system of claim 1, wherein the at least one graphic object rendered and displayed is viewable with a web browser.

7. The system of claim 1, wherein the at least one graphic object rendered and displayed is a representation of a physical control for the machine.

8. The system of claim 1, wherein the at least one graphic object rendered and displayed is a representation of a part of the machine.

9. The system of claim 1, wherein the at least one graphic object rendered and displayed is capable of being displayed at the same size on displays of different resolutions.

10. The system of claim 1, wherein at the least one assigned property of at least one graphical object is stored in a style sheet.

11. The system of claim 10, wherein style sheet is selected from the group consisting of CSS, XSL, and combinations thereof.

12. The system of claim 1, wherein the computer readable code on a computer readable medium in at least one of a), b) and c) is a compiled software component.

13. The system of claim 1, wherein the computer readable code on a computer readable medium In at least one of a), b) and c) comprises functionality that is callable from and executable on a plurality of operating systems.

14. The system of claim 1, wherein the computer readable code on a computer readable medium in at least one of a), b) and c) is scriptable.

15. The system of claim 1, wherein the computer readable code on a computer readable medium in at least one of a), b) and c) comprises at least one Java Bean component.

16. The system of claim 1, further comprising:
d) computer readable code on a computer readable medium for receiving a user input associated with a displayed graphical object corresponding to the at least one controllable part of the machine;
e) computer readable code on a computer readable medium for triggering a change in at least one assigned property of the associated graphical object in response to user input;
f) computer readable code on a computer readable medium for rendering and displaying the associated graphical object following the change in at least one assigned property in response to use input; and
g) computer readable code on a computer readable medium for sending data to the machine control device, the data representing an instruction to perform an associated machine function.

17. A system for providing a plurality of graphical human-machine interfaces for a machine having a plurality of controllable parts, the system comprising:
a machine control device in communication with the machine;
a first computer in communication with the machine control device via a local area network, the first computer comprising computer readable code for receiving information about at !east one controllable part of a machine, the information comprising rendered graphical objects; and
a second computer in communication with the machine control device via a wide area network, the second computer comprising:
computer readable code for receiving information about at least one controllable part of the machine from the machine control device,
computer readable code for triggering a change in at least one assigned property of the at least one graphical object corresponding to the at least one controllable part of the machine, and
computer readable code for rendering and displaying the at least one graphical object following the change in the at least one assigned property, wherein the at least one rendered and displayed graphical object is a scalable vector graphic (SVG) object.

18. A system for providing a graphical human-machine interface for a machine having controllable parts, the system comprising:
at least one software component for execution by a computer in communication with a machine control device via a wide area network, the machine control device being in communication with the machine and the at least one software component configured for receiving information about at least one controllable part of the machine from the machine control device;
at least one software component for execution by a computer in communication with the machine control device via a wide area network for triggering a change in at least one assigned property of the at least one graphical object corresponding to the at least one controllable part of the machine;
at least one software component for execution by a computer in communication with the machine control device via a wide area network for rendering and displaying the at least one graphical object following the change in the at least one assigned property, wherein the at least one rendered and displayed graphical object is a scalable vector graphic (SVG) object;
at least one software component for execution by a computer in communication with the machine control device via a wide area network for receiving a user input associated with a displayed graphical object corresponding to at least one controllable part of the machine;
at least one software component for execution by a computer in communication with the machine control device via a wide area network for triggering a change in the at least one assigned property of the associated graphical object with which the user input is associated;
at least one software component for execution by a computer in communication with the machine control device via a wide area network for rendering and displaying the associated graphical object with which the user input is associated following the change in the at least one assigned property; and
at least one software component for execution by a computer in communication with the machine control device via a wide area network for sending data to the machine control device, the data representing an instruction to perform an associated machine function.

19. A method for providing a graphical human-machine interface for a machine having a plurality of controllable parts, the method comprising the steps of:
receiving information about at least one controllable part of the machine from a machine control device in communication with the machine;
triggering a change in at least one assigned property of the at least one graphical object corresponding to the at least one controllable part of the machine; and
rendering and displaying the at least one graphical object following the change in the at least one assigned property, wherein the at least one rendered and displayed graphical object is a scalable vector graphic (SVG) object.

20. The method of claim 19, wherein the steps of receiving, triggering, and rendering are each performed at a computer configured to receive information from the machine control device via wide area network.

21. The method of claim 19, further comprising the steps of:
receiving a user input associated with a displayed graphical object corresponding to the at least one controllable part of the machine;
triggering a change in at least one assigned property of the associated graphical object in response to user input;
rendering and displaying the associated graphical object following the change in at least one assigned property in response to the user input; and
sending data to the machine control device, the data representing an instruction to perform an associated machine function.

22. A method for providing a plurality of graphical human-machine machine interfaces for a machine having a plurality of controllable parts, the method comprising the steps of:
sending from a machine control device in communication with the machine to a first computer via a local area network information about at least one controllable part of the machine, the information comprising rendered graphical objects;
sending from the machine control device in communication with the machine to a second computer via a wide area network information about at least one controllable part of the machine, the information consisting of non-rendered graphics information;
displaying the received rendered graphical objects at the first computer;
triggering at the second computer a change in at least one assigned property of at least one graphical object corresponding to the at least one controllable part of the machine about which information was received; and
rendering and displaying at the second computer the at least one graphical object following the change In the at east one assigned property, wherein the at least one rendered and displayed graphical object is a scalable vector graphic (SVG) object.

23. The method of claim 22, wherein the wide area network is the Internet.

24. The method of claim 22, wherein the graphical objects displayed at the first computer are GDI+ graphical objects.
